(19) United States
(12) Patent Application Publication
(10) Pub. No.: US 2011/0017323 A1
(43) Pub. Date: Jan. 27, 2011

(54) METHOD AND APPARATUS FOR INLINE TESTING

(76) Inventor: Ewa Herbst, Edgewater, NJ (US)

Correspondence Address: Byrne Poh LLP, 11 Broadway, Ste 865, New York, NY, 10004, US

(21) Appl. No.: 12/507,506

(22) Filed: Jul. 22, 2009

(51) Int. Cl. E03B 7/07; A01J 5/013

(52) U.S. Cl. 137/551; 119/14.17

(57) ABSTRACT

An inline fluid measurement system features a plurality of controllable valve elements inline with one or more fluid conductors; a plurality of sampling stations inline with the closeable automatic valves; a monitoring station having at least one monitoring equipment, the monitoring station being connected using the conduits for receiving samples from respective sampling stations in a prescribed order; and an analysis station connected to the monitoring station and being further connected to control the automatic valves in response to signals from the monitoring station resulting from analysis from the samples.

### BACKGROUND OF THE INVENTION

The invention relates generally to inline testing of fluid material, and in a particular example, to the inline testing of cow's milk for indications of mastitis in the cow, in substantially real time.

Inline testing of fluids has been practiced in many different circumstances. There have been many attempts, for example, to test cow's milk in order to determine the quality of the milk, and in particular looking for mastitis as a degradant of milk quality and potentially requiring an entire batch of milk to be degraded or discarded. In the dairy business, such degraded or discarded milk can cost the industry, today and in the United States alone, more than $2 billion dollars annually.

For the dairy farmer, the problem of degraded milk, which results from, for example, a sick cow, is typically indicated and found, in the first instance, by looking at the cow. For those cows which look ill, samples of the cow's milk can be gathered and sent for analysis, offline. Some period of time later, up to ten or more days in some cases, the results can be obtained. Other, more recent efforts have provided more immediate results, but such devices, such as those manufactured by PortaCheck, require substantial manual labor and are not a practical, long term solution for large dairy cow farms. Thus, to check manually the milk of, for example, 3,000 or more cows using modern milking methods, on a daily basis, is not practical, since it requires substantial manual input. As a result, a more automatic method of inline testing of fluids is needed and would provide not only an overall better fluid quality, for example, of milk, but would relieve the need for manually monitoring the fluid, especially in a large farm or other similar context.

### SUMMARY OF THE INVENTION

An inline fluid measurement system features a plurality of controllable valve elements inline with one or more fluid conductors; a plurality of sampling stations inline with the closeable automatic valves; a monitoring station having at least one monitoring equipment, the monitoring station being connected using the conduits for receiving samples from respective sampling stations in a prescribed order; and an analysis station connected to the monitoring station and being further connected to control the automatic valves in response to signals from the monitoring station resulting from analysis from the samples.

### BRIEF DESCRIPTION OF THE DRAWINGS

Other objects and advantages of the invention will be apparent from the following drawings in which:

FIG. 1 is a general block diagram illustrating an automatic fluid monitoring system with various control elements;

FIG. 2 is a more particular block diagram of a system for batch checking milk from a large number of animals in an automatic fashion;

FIG. 3 is a more particular block diagram of a system for checking milk from a large number of animals in an automatic fashion;

FIG. 4 is a flowchart illustrating operation of the fluid inline monitoring system; and

FIG. 5 is a flowchart illustration operation of the fluid inline monitoring system according to another embodiment of the invention.

### DESCRIPTION OF PARTICULAR EMBODIMENTS

While the invention can be employed advantageously in any number of fluid monitoring applications, it is particularly advantageous with regard to monitoring cow's milk for degradation caused by mastitis at the source, the cow (or other animals that can be milked, for example sheep, goats, etc). Several methods for monitoring cow's milk have been considered. In particular, the method described in a patent application in the name of Kiran Madura, as inventor, titled Method for Early Detection of Mastitis and Inflammation in Mammals, and filed 18 Oct. 2007, describes a particularly advantageous methodology for monitoring cow's milk by testing the milk for various conditions, for example inflammation of the udder. Other examples include a method described in PortaScience's U.S. patent application Ser. No. 10/515,056 describing a methodology, manually implemented, for testing the quality of cow's milk by measuring Somatic Cell Count (SCC). A second assay, also manually implemented, that is described in the literature is called the California Mastitis Test (CMT).

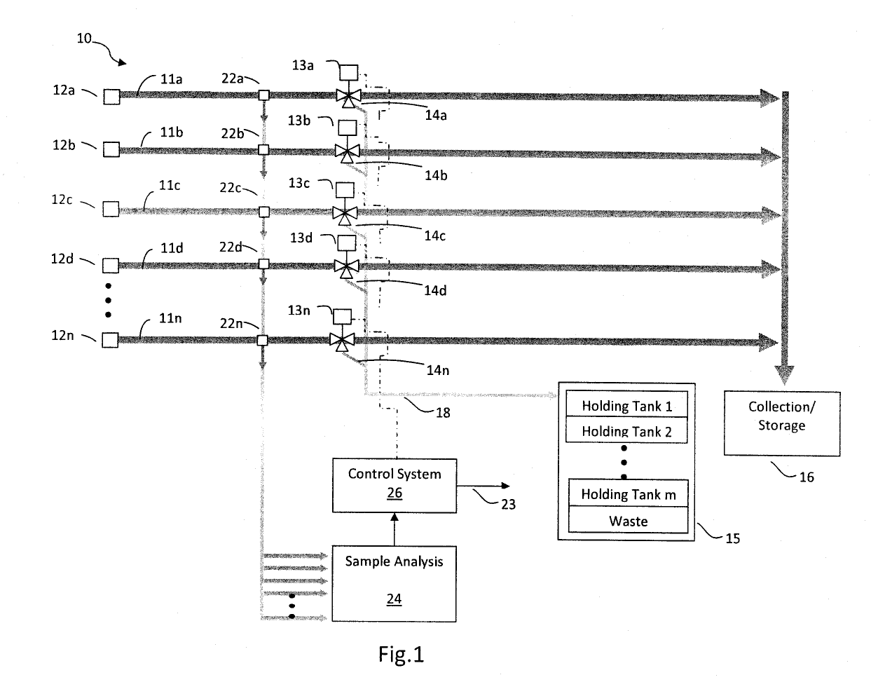

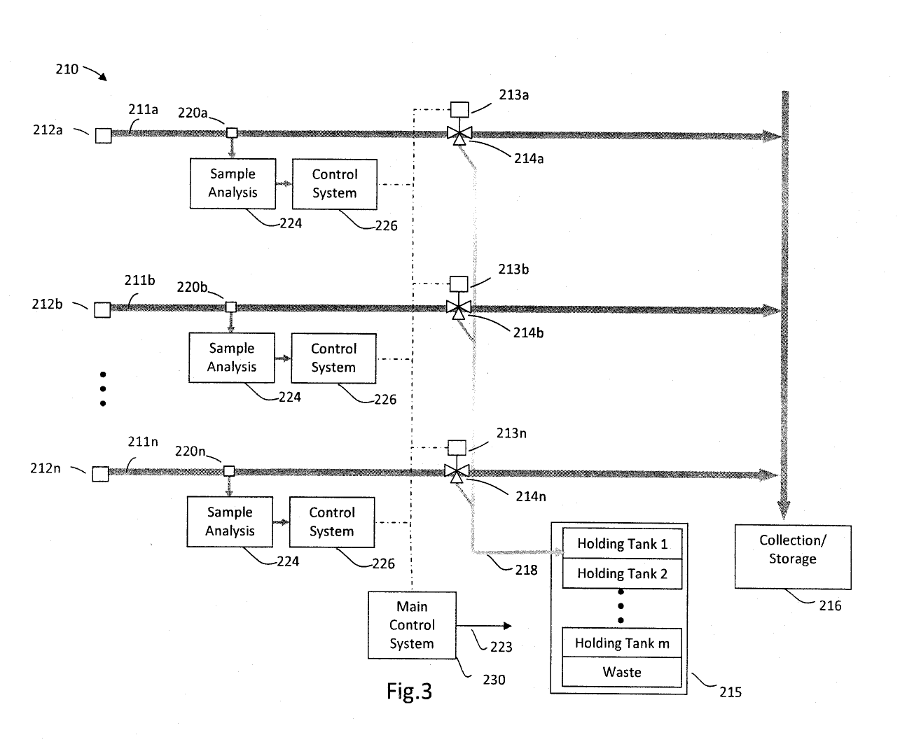

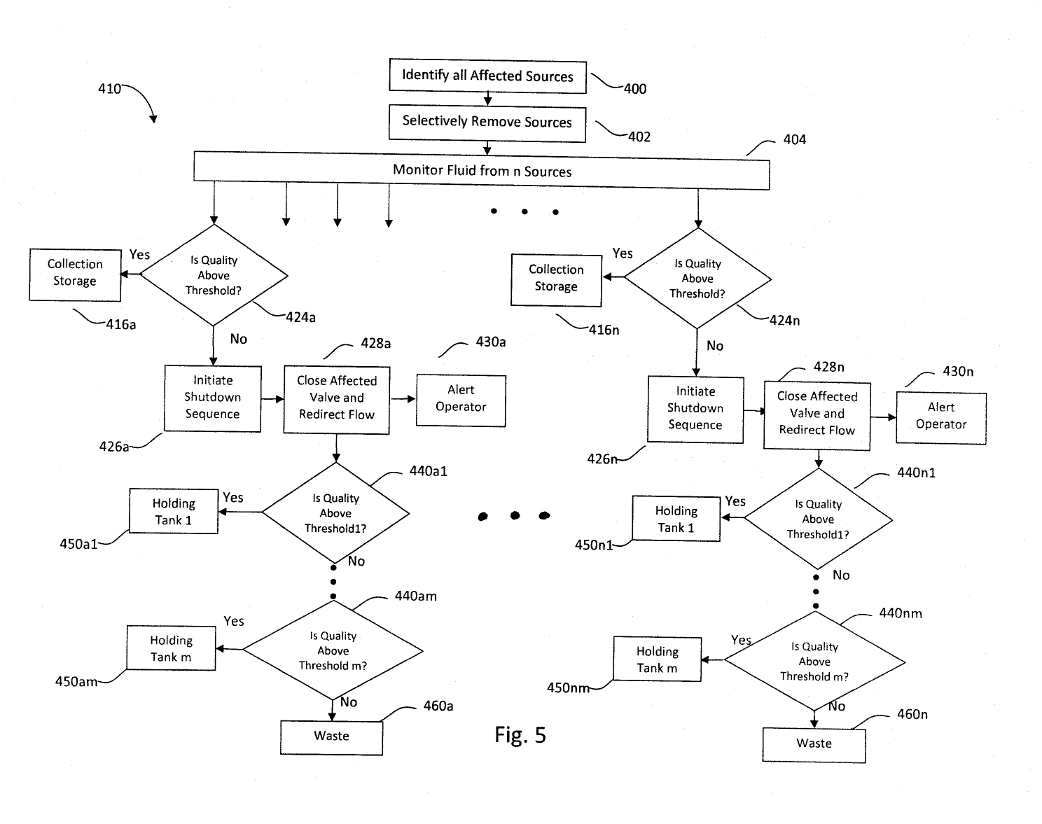

In order to provide a more practical system, which can involve any advantageous assay, the use of detection and monitoring methodologies to detect a poor quality fluid is described in connection with FIG. 1. In accordance with FIG. 1, a continuous monitoring system 10, which may also operate intermittently in order, for example, to timeshare among many fluid lines 11a, 11b, . . . , 11n, monitors the quality of a fluid. In normal operation, the lines 11 connect to a bulk storage container 16. From the source, or sources of the fluid, 12a, 12b, . . . , 12n, an inline monitoring system samples the fluid using sampling apparatus 22a, 22b, 22c, . . . , 22n connected to sample analysis system 24, which determines the quality of the fluid using any convenient and acceptable testing methodology. If the quality is acceptable, no further action is taken, and the system moves on to a next sample of the fluid. If, however, the quality is poor, the sample analysis system 24 signals control system 26, and the control system using/controlling inline valves 13a, 13b, . . . , 13n, over control lines 18 (represented as a single line in the Figures, for convenience) automatically closes the line from that source, and optionally redirects the source fluid to a different receptacle, which can be one of several receptacles based on the quality of the fluid, or to a holding tank or waste system 15, over conduits 14a, 14b, . . . , 14n, whereby the fluid can be tested again, and/or discarded. In addition, the system identifies which source the poor quality fluid is coming from, and alerts the system operator over lines 23 to take some action with regard to the source. That action could be to remove the source, to change certain parameters relating to the source, or otherwise. While the description above describes a serial process, the system, in another embodiment, can sample all of the sources (or a group of sources) in parallel as illustrated and described in connection with FIGS. 3 and 5 below.

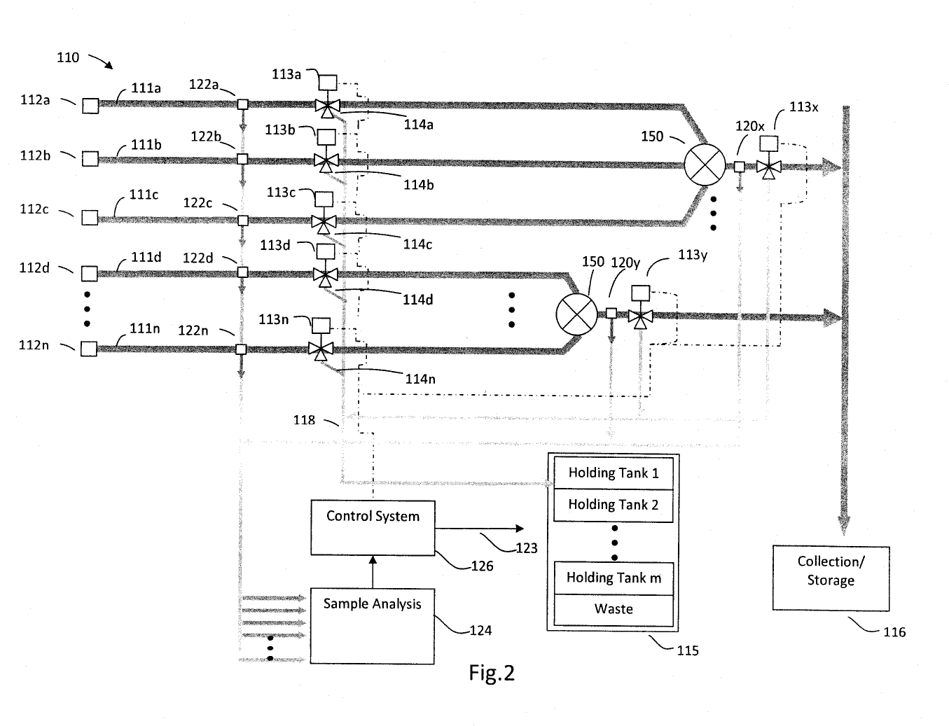

Referring now to FIG. 2, in a particular embodiment of the invention, the source or sources of the fluid are cows. Reference numbers, where appropriate, have been incremented by “100” from the corresponding numbers used in FIG. 1. These animals are milked at least once a day, typically more often, and one sick animal can without monitoring, contaminate an entire batch of milk. As noted above, the loss in the dairy industry for failure to identify sick cows, is upwards or greater than $2 billion dollars in the United States, each year. In accordance with this particular embodiment of the invention, therefore, the cow's milk is monitored substantially at the source at 120a, 120b, . . . , 120n, and a sample is taken of the cow's milk. Samples can be taken continuously or periodically, for example, once a day or otherwise, depending upon the equipment and the number of cows. Furthermore, the initial samples may been taken of either each cow, or of a group of cows at 120x and 120y (milk being combined from several sources in mixers 150 of which there could, of course, be more, connected, for example, in a tree arrangement), so that less sampling may be implemented in the first instance, and more specific sampling can be implemented thereafter in order to isolate a single cow as a source of the degraded or spoiled milk. In any circumstance, once the cow and the milk are identified, the fluid line 111 from the cow can be closed, and as noted above, the cow's milk can be directed using, for example, 3-way, electronically controllable, valves 113 to either a holding tank 115, having one or many receptacles depending on the grades of the milk being collected, and/or sent to a collector/storage container 116. In any instance, this can all be performed automatically, without the need for human intervention. Once the cow has been identified, the cow can be removed and isolated from the milking system, and the valve, previously closed, can be drained or otherwise cleaned, and opened.

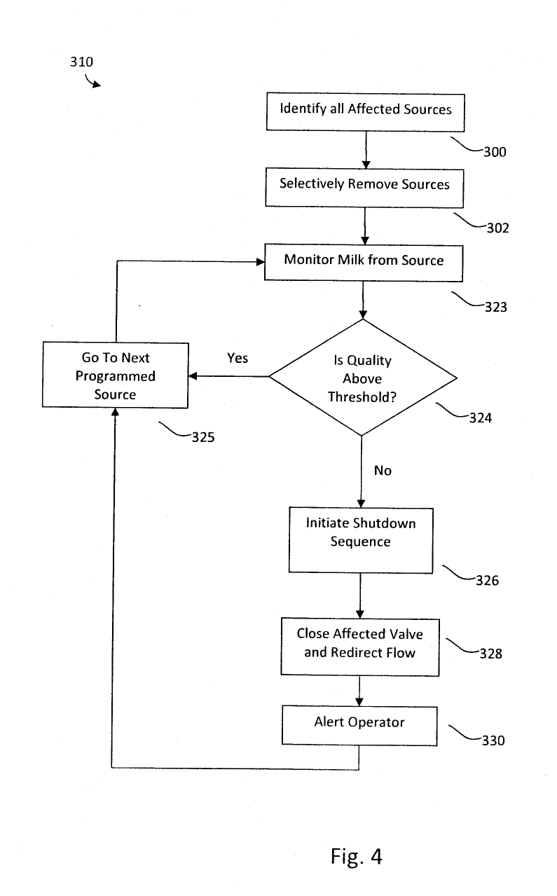

Thus, in accordance with a particular embodiment of the invention, referring to FIG. 4, when the analysis system 110 identifies all affected sources at 300 and selectively removes sources depending, for example, upon fluid quality, at 302. The system monitors at 323 and determines, at 324, that the fluid, for example milk, is of lower quality, it initiates a shutdown sequence, at 326. Otherwise it continues to monitor the next programmed source at 325. In one particular embodiment of the invention, the shut down sequence may only close a certain valve at 328, and alert the farmer or operator, at 330, of the identity of the source (cow) which is producing the lower quality fluid (milk). This can result, for example, upon finding that the fluid (milk) being analyzed exhibits the degraded quality being monitored, for example, resulting from a cow having mastitis.

In a second particular example of the analysis and shutdown system and sequence, when milk from a cow having mastitis is found to have a quality level less than a threshold value, that is, less than some preset level, the system may first automatically shut down a series of milking stations, by, for example, closing a valve which collects milk from each of a plurality of milk stations or shutting down the milking machine at the milking stations, and either alert the farmer that an issue exists at one of these stations, or if the first analysis was of fluid from several sources or stations, the system performs further analysis by thereafter examining and analyzing the milk from each of the stations, or from smaller and smaller groups of stations until the animal which is infecting the milk is identified. In any case, the animal is again taken offline for further examination and treatment. The system illustrated in FIG. 2 implements such a batch, or multiple batch, process. Alternatively, for each cow in the group of cows to which a low quality batch is associated, the cow is recognized and tested the next time the cow comes to a milking station.

In modern, large farms, the improved methodologies for milking cows provide different challenges for testing, identification, monitoring, and solution implementation. In the instance of large automated milking facilities, the cows typically come to the automatic milking machines on their own schedule, typically milking for about 3 to 5 or more minutes, according to the literature. In addition, a particular cow can be at any of a number of milking stations over a period of time. If the monitoring and analysis process lasts longer than a few minutes, the cow will be gone before the results are determined. This encourages tests using assays which do not take a time longer than the milking process. As a result, and for purposes of effective monitoring of the cows, several methodologies need to be in place. First, the cows need to be identifiable when they are being milked. This can be effected using RFID technology and in particular by implanting an RFID tag, in particular by implanting or appropriately attaching to the cow an identification of the cow as currently done in some settings. With this information, either the milk from the cow can be diverted as the cow is milked, or, the milking station can be turned off as noted above, or the cow can itself be intercepted as it leaves the milking facility and diverted for treatment, or the cow can be intercepted as it enters the milking facility the next time, and be diverted and not allowed to be milked. Alternatively, as a sick cow reaches the milking station, the chip can be read and in response an alarm is activated which prevents the“vacuum” controller from operating and no milking takes place. Since this depends on the monitoring process, and the time for doing the analysis, the control system is adjusted to maintain records of which cows were at which stations. Accordingly, monitoring milk batches, while possible, may not in and of itself be sufficient to determine which cow is sick. In addition, the monitoring process can identify cows in which inflammations such as mastitis progress along a known path over a period of time, in order to prevent the cow from giving milk at the time when the inflammation/mastitis has reached a level whereby the milk will be adversely affected. Such a cow will be removed from further milking before its quality degrades below a selected threshold.

Thus, referring to FIG. 3, where the reference numbers for like elements referenced in FIG. 1 have been incremented by “200”, the analysis and control systems of 224 and 226 are made local in this embodiment for different lines/locations, respectively, and can be modified by providing and storing time stamped information through a centralized control system 230, identifying a cow and its status as a result of the monitoring tests, even though the cow may have left the milking station prior to the results being available. The results are then centrally stored and used the next time when the cow returns to any milking station 212. Further, as illustrated in this particular embodiment of the invention, multiple receptacles. Holding tanks 215 and collection/storage 216 can be provided and filled with milk having no or different levels of degradation, as controlled by control system 230 through three-way valves 213.

Referring to FIG. 5, in a system which works in parallel, system 410 operates to first identify all affected sources at 400. The affected sources are then selectively removed from, for example, being milked in a milking station, at 402, and the remaining sources are monitored at 404 in parallel. By monitoring the sources in parallel, each of the sources can, at the same time, be tested so that a sick cow, for example, does not pass and move away from the milking station at a time before the test results are obtained. Thus, and preferably, if the test process is fast enough, a cow at a milking station, for example, can have its milk tested at 404 and before it leaves the milking station, a quality result can be compared to a threshold at 424a, 424b, . . . , 424n. If the quality is above a preset threshold level, then the milk goes to the collection storage tanks, at 416; however, if the quality is below the threshold, the system initiates a shut down sequence at 426. While different shutdown sequences are within the scope of the invention, in this illustrated embodiment, several thresholds are used in order to maximize the use of the resulting fluid, for example, milk. Thus, the system first closes the affected valve and redirects the flow at 428 and further alerts the operator at 430. After the valve has been changed to redirect the flow, the system, in this embodiment, checks the quality against a second threshold at 440a, and if the quality is above the second threshold, the milk is directed to a holding tank labeled “Holding Tank 1” at 450a. Several threshold levels can be compared against the measured quality using decision boxes 440, until a final test is made to determine if the quality is above the lowest threshold, threshold m in the illustrated embodiment. If the quality is above the threshold m, then the flow is directed to holding tank m at 450, and if the quality is not above threshold m, the fluid is directed to a waste facility, step 460. The number of threshold determining steps will vary in accordance with the application in order to maximize the value of the fluid product from the source. Thus, referring in particular to a milk product, milk of different qualities can be used for different purposes. Thus as illustrated in FIG. 5, the system can monitor n different sources simultaneously, and from each source, can test up to m different threshold levels.

As desired, the particular analysis employed can change easily and simply, by making the analysis unit 224 “modular”. Thus, it may be more reliable and desirable to, for example, look for multiple proteins using different antibodies and secondary antibodies in the analysis. More information regarding specific analysis approaches is available in the above-identified United States patent application. In particular, as an example, an optical platform can be used to identify, for example, cow mastitis, by shining light at the correct wavelength on the sample and recording measurements from the sample using a spectrophotometer. This in effect creates a platform for multiple biomarkers which are indicative of cow mastitis or other disease(s) or measurement(s) being asserted. Further, by using multiple wavelengths, as indicative of the condition to be measured, more accurate and reliable results can be achieved.

Other objects featured and advantages will be apparent to those practiced in the field, and are within the scope of the following claims.

What is claimed is:

1. An inline fluid measurement system comprising:
a plurality of controllable valve elements inline with one or more fluid conductors;
a plurality of sampling stations inline with the closeable automatic valves;
a monitoring station having at least one monitoring equipment, the monitoring station being connected using said conduits for receiving samples from respective sampling stations in a prescribed order; and
an analysis station connected to the monitoring station and being further connected to control the automatic valves in response to signals from the monitoring station resulting from analysis from the samples.
